(19) United States
(12) Patent Application Publication
(10) Pub. No.: US 2026/0246677 A1
(43) Pub. Date: Aug. 20, 2026

(54) METHOD AND APPARATUS FOR REFERENCE SIGNAL TRANSMISSION IN CALIBRATION OF INTERFERENCE CANCELLATION IN MOBILE COMMUNICATIONS

(71) Applicant: MediaTek Singapore Pte. Ltd., Singapore (SG)

(72) Inventor: Jozsef Gabor NEMETH, Cambridge (GB)

(21) Appl. No.: 19/164,273

(22) PCT Filed: Apr. 10, 2024
(86) PCT No.: PCT/CN2024/086914

§ 371 Date: Sep. 11, 2025

Related U.S. Application Data
(60) Provisional application No. 63/495,124, filed on Apr. 10, 2023.

(51) Int. Cl. H04L 27/26; H04L 5/00

(52) U.S. Cl. CPC H04L 27/261; H04L 5/0044; H04L 5/0078

(57) ABSTRACT

Examples pertaining to reference signal transmission in calibration of interference cancellation in mobile communications are described. A user equipment (UE) determines a value associated with a timing advance of a reference signal according to a transmission band of the reference signal. The UE transmits the reference signal in the transmission band with the timing advance. In an event that the transmission band of the reference signal overlaps a downlink sub-band, the value associated with the timing advance is set to zero.

### CROSS REFERENCE TO RELATED PATENT APPLICATION(S)

The present disclosure is part of a non-provisional application claiming the priority benefit of U.S. Patent Application No. 63/495,124, filed 10 Apr. 2023, the content of which herein being incorporated by reference in its entirety.

### TECHNICAL FIELD

The present disclosure is generally related to mobile communications and, more particularly, to reference signal transmission in calibration of interference cancellation of a communication apparatus in mobile communications.

### BACKGROUND

Unless otherwise indicated herein, approaches described in this section are not prior art to the claims listed below and are not admitted as prior art by inclusion in this section.

In wireless communication environments, wireless signals transmitted or broadcast by nodes or apparatuses in a wireless network may cause interference. In addition, for a sub-band full-duplex (SBFD) capable communication apparatus (e.g., a user equipment (UE)), the leakage of uplink (UL) transmission may contaminate its downlink (DL) reception and become an interference to the communication apparatus. Therefore, interference cancellation is an important operation to a communication apparatus in the wireless network.

Ideally, the interference cancellation needs to be accurately trained or calibrated prior to an actual symbol transmission or reception. However, in the conventional designs, the communication apparatuses may only perform opportunistic training or calibration in real wireless communication environments. For example, the calibration may take place only when a communication apparatus has something to send in uplink.

Accordingly, how to improve the calibration operation of interference cancellation becomes an important issue for the newly developed wireless communication network.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to reference signal transmission in calibration of interference cancellation with respect to a communication apparatus (e.g., a UE) and a network apparatus (e.g., a network node or a base station (BS), such as a next generation Node B (gNB)) in mobile communications.

In one aspect, a method may involve a communication apparatus determining a value associated with a timing advance of a reference signal according to a transmission band of the reference signal. The method may also involve the communication apparatus transmitting the reference signal in the transmission band with the timing advance. In an event that the transmission band of the reference signal overlaps a downlink sub-band, the value associated with the timing advance is set to zero.

In one aspect, an apparatus may comprise a transceiver which, during operation, wirelessly communicates with at least one network node. The apparatus may also comprise a processor communicatively coupled to the transceiver. The processor, during operation, may perform operations comprising determining a value associated with a timing advance of a reference signal according to a transmission band of the reference signal. The processor may also perform operations comprising transmitting, via the transceiver, the reference signal in the transmission band with the timing advance. In an event that the transmission band of the reference signal overlaps a downlink sub-band, the value associated with the timing advance is set to zero.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a diagram depicting an example scenario under schemes in accordance with implementations of the present disclosure.

FIG. 8 is a diagram depicting an example scenario under schemes in accordance with implementations of the present disclosure.

FIG. 9 is a diagram depicting an example communication system in accordance with an implementation of the present disclosure.

FIG. 10 is a flowchart depicting an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to reference signal transmission in calibration of an interference cancellation operation of a communication apparatus, especially a SBFD capable communication apparatus. According to the present disclosure, a number of possible solutions may be implemented separately or jointly. That is, although these possible solutions may be described below separately, two or more of these possible solutions may be implemented in one combination or another.

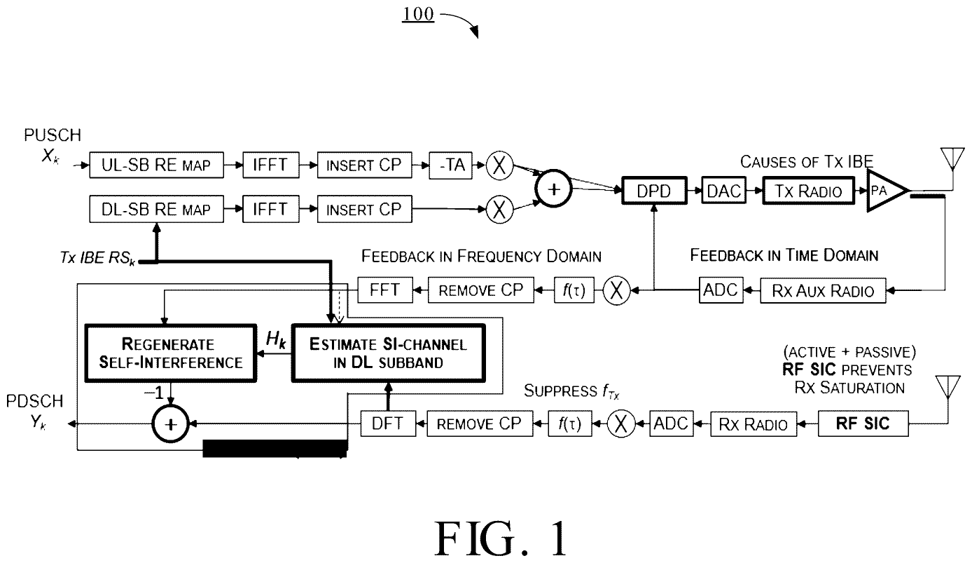

FIG. 1 illustrates an example scenario 100 under schemes in accordance with implementations of the present disclosure. Scenario 100 illustrates the exemplary signal processing in a transmission chain (Tx chain, shown in the upper portion) of a communication apparatus, and the exemplary signal processing with interference cancellation in a receiving chain (Rx chain, shown in the lower portion) of the communication apparatus.

In the Tx chain, the transmission signal (e.g., the Tx signal Xₖ) may be mapped to uplink sub-band (UL-SB) resource element (RE) and inverse fast Fourier transformed (IFFT). The cyclic prefix (CP) may be inserted and a timing advance (TA) may be applied to the Tx signal as well. The transmission signal may further undergo digital pre-distortion (DPD), digital to analog conversion (DAC), analog front-end signal processing (e.g., by the Tx radio) and gain adjustment (e.g., by the power amplifier (PA)) before being transmitted.

In an event that the communication apparatus is a SBFD capable communication apparatus, the communication apparatus is capable of performing concurrent UL transmission and DL reception. Therefore, the communication apparatus has to deal with the interference from its UL transmission to its DL reception (e.g., the UL-to-DL interference, which is also named as the self-interference (SI)).

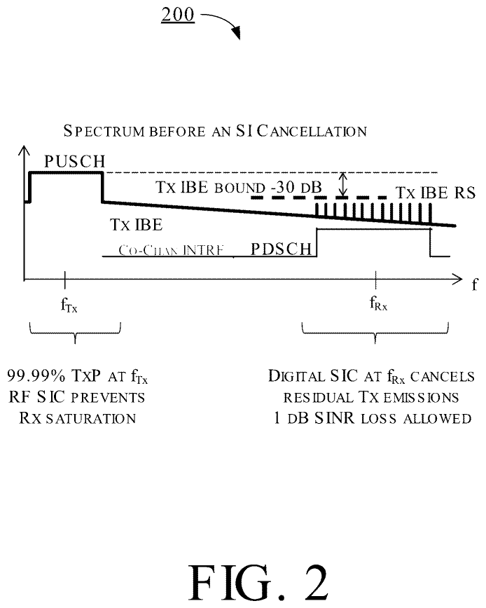

FIG. 2 illustrates an example scenario 200 under schemes in accordance with implementations of the present disclosure. Scenario 200 illustrates a power density spectrum before an SI cancellation is performed. The UE may perform a UL transmission (e.g., on a physical uplink shared channel (PUSCH)) and a DL reception (e.g., on a physical downlink shared channel (PDSCH)) in overlapped time duration. Specifically, the UE may transmit the PUSCH in the transmission bandwidth (TxBW) with a central frequency at f_{Tx} and receive the PDSCH in the reception bandwidth (RxBW) with a central frequency at f_{Rx}.

Scenario 200 further illustrates that the leakage of UL transmission may start higher at the transmission bandwidth TxBW and keep decreasing through the frequency bandwidth between the UL transmission and the DL reception. The leakage of UL transmission may contaminate the DL reception and generate an unwanted transmission (Tx) in-band emission (Tx IBE). Thus, it is desired that the Tx IBE can be attenuated or cancelled to avoid overloading the receiver and/or affecting the DL reception.

In some implementations, the UE may superpose at least one reference signal (RS), such as a pilot tone or a pilot signal, over the original UL signal. In some implementations, the reference signal may be a wideband pilot and may sample the bandwidth of the DL signal of interest, such as the reference signal Tx IBE RS illustrated in FIG. 2. The power of the superposed reference signal stays below the Tx IBE bound and does not harm the linearity of the receiver. The superposed reference signal may be utilized in self-interference cancellation (SIC) (including the training or calibration of the interference cancellation or the training or calibration of the SIC).

In some implementations, the reference signal may act as a power boosted known pilot signal, which improves accuracy and latency of the SIC adaptation (i.e., the aforementioned training or calibration of the SIC). Adding the reference signal allows wideband channel estimation and this enhancement could be necessary for reaching the 1 dB signal-to-interference-plus-noise ratio (SINR) loss target.

In some implementations, accurate and fast SI channel estimation may require sampling the spectrum with one or more pilot signals or pilot tones (subcarriers) having boosted power level, which provides high signal-to-noise ratio for the SI estimation. Using the pilot tones, only selected subcarriers (resource elements) need to be muted within the first 1 or 2 symbols.

Referring to FIG. 1, the radio frequency self-interference cancellation (RF SIC) may be performed first in the Rx chain. After the RF SIC, the receiving signal may undergo analog front-end signal processing (e.g., by the Rx radio) and analog to digital conversion (ADC) before a frequency conversion (e.g., by the mixer). After suppressing the signal components at the frequency f_{Tx}, removing the CP and performing the digital Fourier transform (DFT), the signal is provided to the digital SIC (DSIC) for a subsequent interference cancellation.

In some implementations, a feedback path from the Tx chain to the Rx chain may be provided, to assist the SI channel estimation and SI regeneration in the DSIC. In some implementations, a model may be involved in the DSIC to regenerate the self-interference. In some implementations, the interference cancellation operation has to be well trained or calibrated to accurately perform interference cancellation.

In some implementations, the interference cancellation, such as SIC, may be trained or calibrated prior to symbol of concurrent UL transmission and DL reception. The calibration (or training) may be scheduled periodic or aperiodic. The calibration (or training) may also comprise on-the-fly calibration or on-the-fly training while DL is suspended or not yet started, and fine-tracking e.g., during UL repetitions.

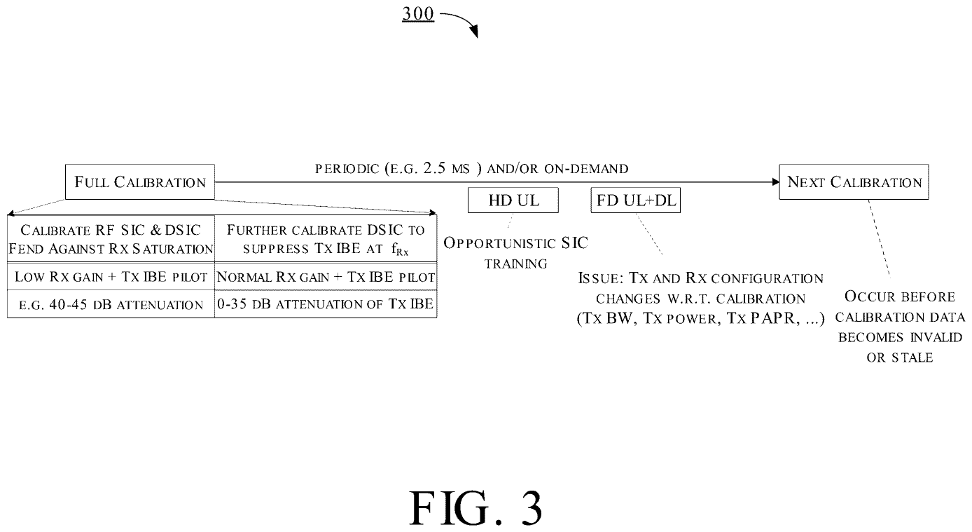

FIG. 3 illustrates an example scenario 300 under schemes in accordance with implementations of the present disclosure. A full calibration may be performed before actual UL transmission or DL reception. The RF SIC or both the RF SIC and DSIC may be calibrated first in a first stage. To fend against Rx saturation, a low Rx gain may be utilized. In addition, a reference signal or a Tx IBE pilot signal, such as the Tx IBE reference signal Tx IBE RS_{K} illustrated in FIG. 1 or the Tx IBE RS illustrated in FIG. 2, may be transmitted by the UE to facilitate channel estimation.

The DSIC may be further calibrated in a second stage with a normal Rx gain to suppress the Tx IBE at the frequency f_{Rx}. An on-the-fly training, which may be an opportunistic SIC training, may be carried out during half-duplex (HD) UL transmission. When the UE is in the full-duplex (FD) mode, e.g., the UL information transmitting and DL information receiving are overlapping in time, the UE may continue to track the interference, and to determine whether the Tx and Rx configuration changes and/or whether the calibration data obtained in a previous calibration procedure becomes invalid or stale. A next calibration may be performed based on the periodicity or on-demand (e.g., when the calibration data becomes invalid or stale).

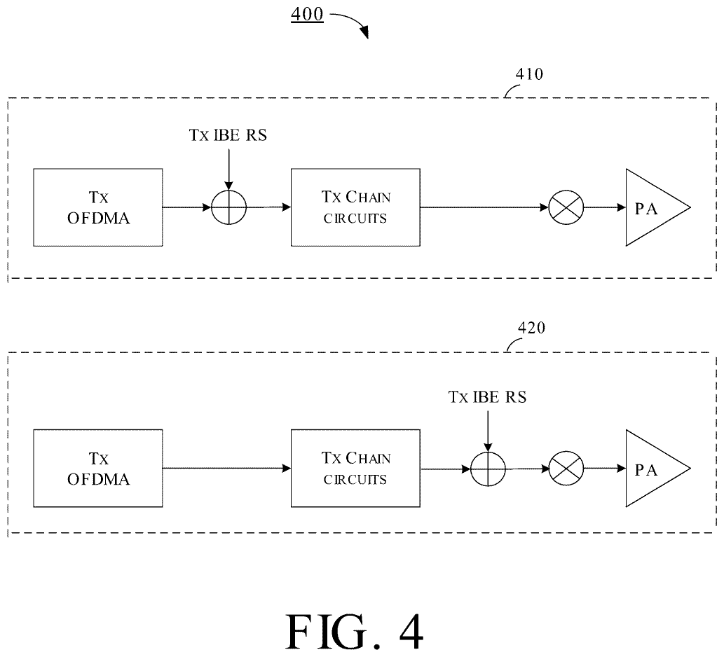

FIG. 4 is a diagram depicting an example scenario 400 of two options of inserting the reference signal under schemes in accordance with implementations of the present disclosure. In some implementations, the orthogonal frequency division multiple (OFDM) signal generation may be performed by or after the Tx orthogonal frequency division multiple access (OFDMA) block shown in FIG. 4, and the Tx chain circuits may comprise one or more digital signal processing circuits and one or more analog signal processing circuits, such as the blocks and/or circuits in the Tx chain as depicted in FIG. 1.

In some implementations, the reference signal, such as but limited to the Tx IBE RS, may be superposed over the original UL signal or Tx waveform before or after digital-to-analog conversion. In some implementations, the reference signal may be added to the Tx waveform by linear superposition outside or inside the Tx waveform bandwidth.

In some implementations, there may be two options of inserting the reference signal. In the first option 410, the Tx IBE RS is added to the digital baseband Tx waveform. In the second option 420, the Tx IBE RS is inserted before a frequency up-conversion and thus added to the input of a mixer circuit. Noted that the second option may be motivated by Tx noise filtering in Tx path.

In some implementations, the reference signal (e.g., the Tx IBE RS) may be inserted by RE mapping before IFFT in frequency domain or added to the time-domain waveform post IFFT.

In some implementations, the reference signal (e.g., the Tx IBE RS) may be transmitted at least in a stage of training or calibrating the interference cancellation operation in RF SIC and/or DSIC (that is, the SIC training or SIC calibration). In some implementations, the reference signal may be applied only during calibration or training stage.

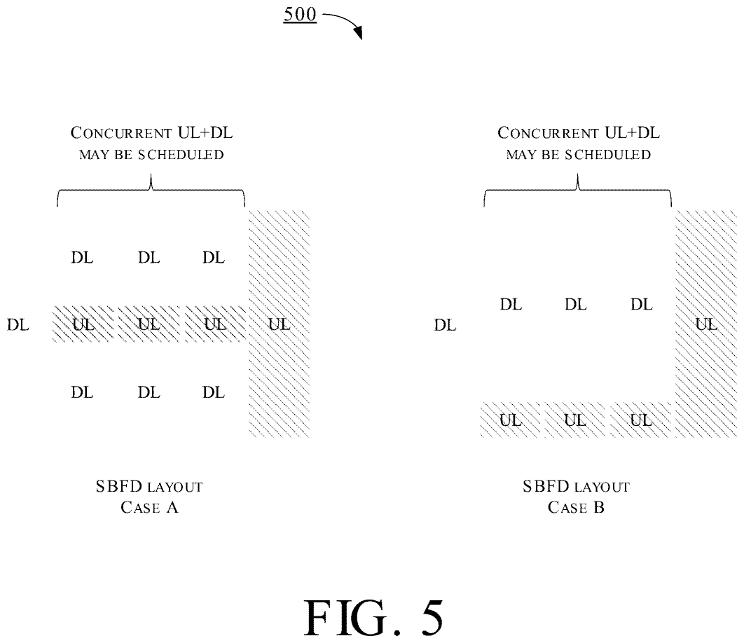

FIG. 5 illustrates an example scenario 500 under schemes in accordance with implementations of the present disclosure. Scenario 500 illustrates two exemplary cases of SBFD layout. The time-frequency resources may be allocated for DL or UL. Certain symbols may also be flexible, or potentially, scheduling may override the UL sub-band. The difference between SBFD case A and SBFD case B is that in case B, the DL sub-band is a contiguous region.

In some implementations, to achieve effective calibration or training, the communication apparatus (e.g., the UE) may inform the network node of its resource requirements for calibration. More specifically, in some implementations, the UE may transmit a request message to a network node to request a resource for calibration, receive a configuration of the resource from the network node and perform a calibration procedure on the resource to calibrate an interference cancellation operation.

In some implementations, the request message may identify at least one of a duration, a periodicity and a frequency band associated with the calibration procedure. In some implementations, the UE may specify a desired duration of the calibration procedure that needs to be covered by the resource. In some implementations, the UE may specify a desired periodicity of the calibration that needs to be covered by the resource.

In some implementations, the calibration procedure may be performed or the request message may request the resource to be scheduled before a DL reception or a UL transmission of the UE, during a UL transmission while a concurrent DL reception is suspended or during a UL transmission overlapping with a concurrent DL reception in time.

In some implementations, the calibration procedure may be performed aperiodically or opportunistically on the resources detected by UE and/or using network assistance.

In some implementations, the resource configured by the network node may comprise one or more resources allocated for a sounding reference signal (SRS), a pilot signal or a pilot tone (such as the Tx IBE RS), a channel state information (CSI) for interference measurement (IM) (CSI-IM), a non-zero-power (NZP) reference signal (RS) or a zero-power (ZP) RS.

In some implementations, the resource allocated for the reference signal (e.g., the SRS) to implement SIC calibration may be a training-SRS. In some implementations, the “training-SRS” may refer to: the SRS (or other existing RS) reused for calibration or new RS introduced for calibration. As an example, the Tx IBE RS may reuse the SRS that is currently specified in the 3rd generation partnership project (3GPP) standard and possibly with a different configuration.

In some implementations, the location and power of the RE associated with the reference signal transmitted for interference cancellation or for SIC calibration (e.g., SIC training) may be scheduled by the network node, as an example, based on the request message. In some implementations, the UE may linearly superpose the reference signal to the Tx waveform in frequency resource blocks covering at least the DL reception bandwidth (e.g., by the DL-SB RE map block and the corresponding signal processing path as depicted in FIG. 1).

In some implementations, the calibration may employ special training signal (i.e., the aforementioned reference signal) in UL sub-band or DL sub-band scheduled by gNB. The reference signal may be a wideband pilot signal transmitted by the UE in UL sub-band or in the DL sub-band below the Tx IBE mask or the Tx IBE bound as introduced above, to support wideband SI-channel estimation. The spectral resources required by calibration may depend on UE's implementation and channel conditions.

In some implementations, the SI channel estimation may be performed in either the UL sub-band or the DL sub-band at a Tx power lower than a normal Tx power. In some implementations, the power level of the reference signal transmitted in a DL-only symbol or a DL sub-band may be independent of UL transmit power control (TPC). In some implementations, the power level of the reference signal transmitted in a UL-only symbol or a UL sub-band may be selected to be independent of UL TPC.

In some implementations, the resource element (RE) (e.g., a DL RE) where the UE's reception would overlap in frequency and in time with a scheduled reference signal may be muted. In some implementations, the location of the muted RE may be signalled to the UE and it may be left to UE implementation to use these resources to transmit the reference signal below the Tx IBE bound.

In some implementations, in the performing of the calibration procedure on the resource, the UE may transmit the reference signal in the sub-band or symbol configured to the UE and perform interference measurement based on the reference signal.

In some implementations, the UE may perform a channel estimation of the SI channel according to a measurement performed on the resource and determine calibration data of the model which models the SI channel in the interference cancellation operation based on the channel estimation. In some implementations, the UE may determine whether the calibration data is valid, and transmit a report to the network node in an event that the calibration data becomes invalid or stale. In some implementations, the report may be comprised in a measurement report (e.g., as a part of a channel quality indicator (CQI) report) or a medium access control (MAC) control element (CE).

In some implementations, regarding the transmission of the reference signal, the timing advance (TA) used with the reference signal may be different from the timing advance used with one or more signals and/or one or more channels used in the UL transmission. In some implementations, the one or more signals and/or one or more channels used in the uplink transmission may comprises at least one of a PUSCH, a physical uplink control channel (PUCCH), an SRS and a physical random access channel (PRACH).

In some implementations, the communication apparatus (e.g., the UE) may determine a value associated with the timing advance of the reference signal according to a transmission band of the reference signal and transmit the reference signal in the transmission band with the timing advance. In some implementations, in an event that the transmission band of the reference signal overlaps a DL sub-band, the value associated with the timing advance is set to zero.

In some implementations, the reference signal may comprise at least one of a pilot signal, an SRS and the Tx IBE RS transmitted for interference cancellation, as introduced above.

In some implementations, the timing advance of the reference signal may comprise a timing offset TA_offset and an adjustment (e.g., an adjustment according to round-trip time (RTT)). For example, the timing advance TA may be expressed as: TA=TA_offset+Adjustment according to RTT.

In some implementations, the value associated with the timing advance may be a value of the timing offset or a value of the timing advance. Specifically, in some implementations, the value associated with the timing advance may be set to zero by setting the value of the timing offset TA_offset to zero, that is, TA_offset=0. In some alternative implementations, the value associated with the timing advance may be set to zero by setting the value of the timing advance to zero, that is, TA=0.

In some implementations, the value associated with the timing offset TA_offset or the timing advance TA may depend on whether the reference signal is allocated in the UL sub-band or the DL sub-band, or in a DL-only symbol or in an UL-only symbol. In some implementations, a normal value associated with the timing advance TA and the timing offset TA_offset may be used in the UL sub-band and in an UL-only symbol or slot, whereas TA=0 or TA_offset=0 may be used in the DL sub-band or in a DL-only symbol.

In some implementations, the value associated with the timing offset TA_offset or the timing advance TA may also depend on the power level of the transmitted signal. In some implementations, a power level of the reference signal is configured separately from a power level of a sounding reference signal (SRS). In some implementations, the UE may set a power level of the reference signal to a predetermined level not higher that a predefined threshold. In some implementations, a low power level reference signal may use TA=0 or TA_offset=0.

In some implementations, whether to set the value of the timing offset or the value of the timing advance to zero may be selected or determined based on a dynamic signaling or a configuration, such as a semi-static configuration.

In some implementations, the value associated with the timing advance of the reference signal may also depend on UE implementation specific parameter(s). In some implementations, the specific parameter(s) may be part of the UE capability report.

In some implementations, a timing advance of a transmission in an uplink sub-band is set to a non-zero value while the value associated with the timing advance of the reference signal is set to zero. Specifically, in some implementations, the transmission in the uplink sub-band uses a timing advance TA while the transmission of the reference signal does not.

In some implementations, in an event that the transmission band of the reference signal overlaps the DL sub-band, the UE may align a boundary of the reference signal with a boundary of a DL symbol.

In some implementations, in an event that the transmission band of the reference signal overlaps the UL sub-band, the UE may align a boundary of the reference signal with a boundary of an UL symbol.

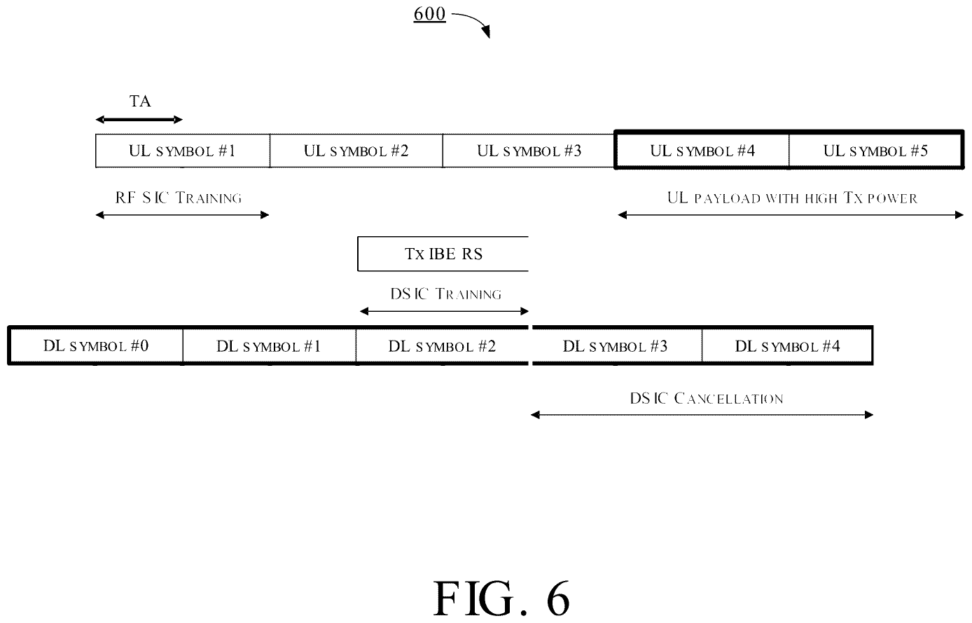

FIG. 6 illustrates an example scenario 600 under schemes in accordance with implementations of the present disclosure. Scenario 600 illustrates an exemplary time division duplexing (TDD) timing diagram of an UL symbol grid and a DL symbol grid. In TDD, the UL symbols may be transmitted with timing advance that includes Tx-Rx turn-around (e.g., the Tx-Rx turn-around of 13 us, which may be equal to 40% of T_symbol). For co-existence with legacy TDD UEs, this timing advance may be maintained in SBFD network.

The UL symbol #1 may contain a reference signal (such as an SRS) for RF SIC training and UL sub-band SI-channel estimation. In some implementations, the transmission band of the SRS may overlap the UL sub-band, and the UE may align a boundary of the SRS for RF SIC training with the boundary of the UL symbol #1 as depicted in FIG. 6.

In some implementations, the RF SIC training may take place with low signal power level concurrently to uplink transmission of other UE's and therefore, it is aligned with the UL symbol timing. In some implementations, either a common or a separate digital Tx path may be used for the Tx IBE RS. In some implementations, by using low Tx power, the RF SIC training may overlap other UE's UL transmissions.

In some implementations, the UL symbol #1 may be transmitted with low power to train RF SIC. Inter-UE multiplexing may be solved in the power domain or with frequency interleaving. Following the initial RF SIC training, the channel may be tracked during the subsequent symbols. The symbol may be multiplexed in power domain with another UE, and the first UL symbol carrying payload is #4.

In some implementations, to perform DSIC training, a reference signal (such as the Tx IBE RS) may be transmitted on subcarriers where DL symbol #2 has muted REs. The Tx IBE RS transmission may start earlier than the transmission of the UL payload.

In some implementations, the Tx IBE RS may be transmitted in the DL sub-band, and the UE may align the Tx IBE RS with the DL symbol timing. In some implementations, a separate digital Tx path for the Tx IBE RS may be used, such as the path shown in FIG. 1 without a TA applied to the Tx IBE RS. In some implementations, the UE may align a boundary of the Tx IBE RS with the boundary of the DL symbol #2 as depicted in FIG. 6 in an event that the transmission band of the Tx IBE RS overlaps the DL sub-band.

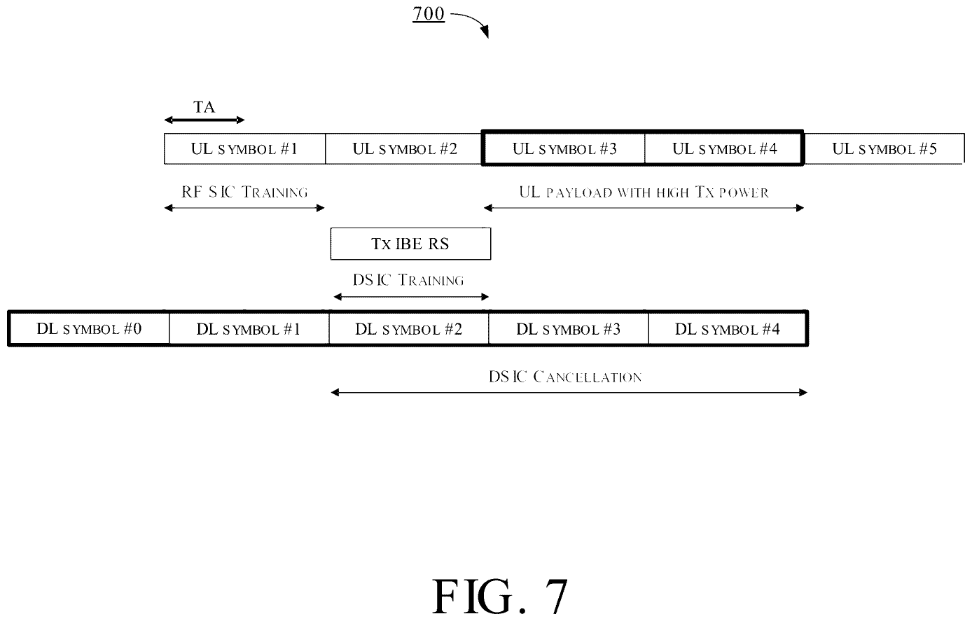

FIG. 7 illustrates an example scenario 700 under schemes in accordance with implementations of the present disclosure. Scenario 700 illustrates an exemplary frequency division duplexing (FDD) timing diagram of an UL symbol grid and a DL symbol grid. In FDD, the UL symbols may be transmitted with timing offset TA_offset=0. The RTT and TA are in the order of 0-2 us (comparable to CP duration), which is tolerable for a DSIC attenuation of 0-25 dB. Legacy TDD UEs use the TDD timing advance. Therefore, two different timing advances are used in SBFD network, avoiding collisions.

The UL symbol #1 may contain a reference signal (such as an SRS) for RF SIC training and UL sub-band SI-channel estimation. In some implementations, the transmission band of the SRS may overlap the UL sub-band, and the UE may align a boundary of the SRS for RF SIC training with the boundary of the UL symbol #1 as depicted in FIG. 7.

In some implementations, the RF SIC training may take place with low signal power level concurrently to uplink transmission of other UE's and therefore, it is aligned with the UL symbol timing. In some implementations, either a common or a separate digital Tx path may be used for the Tx IBE RS. In some implementations, by using low Tx power, the RF SIC training may overlap other UE's UL transmissions.

In some implementations, the UL symbol #1 may be transmitted with low power to train RF SIC. Inter-UE multiplexing may be solved in the power domain or with frequency interleaving. Following the initial RF SIC training, the channel may be tracked during the subsequent symbols. The symbol may be multiplexed in power domain with another UE, and the first UL symbol carrying payload is #3.

In some implementations, to perform DSIC training, a reference signal (such as the Tx IBE RS) may be transmitted on subcarriers where DL symbol #2 has muted REs. The Tx IBE RS transmission may start earlier than the transmission of the UL payload.

In some implementations, the Tx IBE RS may be transmitted in the DL sub-band, and the UE may align the Tx IBE RS with the DL symbol timing. In some implementations, a separate digital Tx path for the Tx IBE RS may be used, such as the path shown in FIG. 1 without a TA applied to the Tx IBE RS. In some implementations, the UE may align a boundary of the Tx IBE RS with the boundary of the DL symbol #2 as depicted in FIG. 7 in an event that the transmission band of the Tx IBE RS overlaps the DL sub-band.

In some implementations, the reference signal may be limited to certain subcarriers (and certain symbols), or have a different subcarrier spacing (SCS). In some implementations, the reference signal may be limited to subcarriers and symbols according to rules pre-stored or pre-configured to the UE and/or pre-defined in the standard.

In some implementations, the reference signal may be limited or restricted to subcarriers and symbols (i.e., resource elements) where collision with DL or UL scheduled allocations can be avoided, for example, where the DL REs are muted (e.g. by zero-power (ZP) RS or interference measurement RS; or new ZP RS signals for this purpose may be introduced), the UL REs are muted, or the DL or UL resources are not scheduled. In some implementations, the reference signal may not collide with DL demodulation reference signal (DMRS).

In some implementations, the reference signal may have pre-configured or ad-hoc phases and/or magnitudes. In some implementations, the reference signal may have cyclic prefix (CP). In some implementations, the numerology and CP size of the reference signal may match the DL transmission.

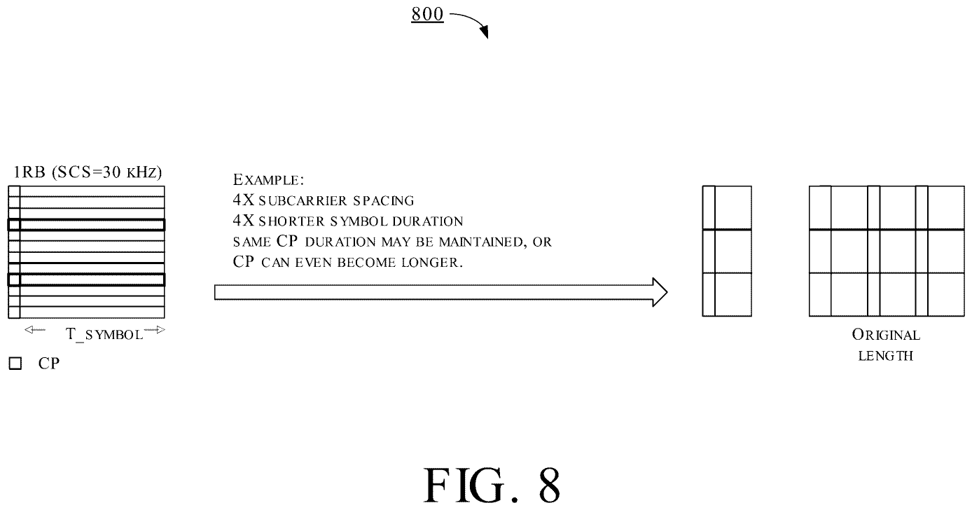

FIG. 8 illustrates an example scenario 800 under schemes in accordance with implementations of the present disclosure. Scenario 800 illustrates that for shortened reference signal duration, when needed, the carrier spacing may be increased, maintaining orthogonality when averaging over the reference signal duration. As an example, a normal resource block (RB) is shown on the left side of FIG. 8. For a shortened reference signal duration, the SCS may be 4 times increased and the symbol duration is 4 times shorten as well. In addition, the same CP duration may be maintained or the CP duration may become longer.

In some implementations, the reference signal may be multiplexed with the uplink transmission in a frequency domain. In some implementations, multiple SRS may be frequency-multiplexed, wherein one of them may be the reference signal transmitted for SIC training and SI-channel estimation. In some embodiments, the SRS applied as the reference signal or applied as the Tx IBE RS may have a separate power level configuration from the other SRS.

In some embodiments, the reference signal (e.g., the SRS or training-SRS) may be frequency multiplexed with UL PUSCH or PUCCH while it may apply different timing advance or no timing advance. In some embodiments, signals or channels multiplexed with the reference signal (e.g., the SRS or training-SRS) may comprise at least one of the PUSCH, the PUCCH, the SRS not used for the purpose of SIC training or SIC calibration and the PRACH.

In some embodiments, for a PUSCH in UL sub-band multiplexed with the reference signal (e.g., the SRS or training-SRS) in DL sub-band, these two transmissions may not need to apply or use the same timing advance. In some embodiments, for an SRS in UL sub-band multiplexed with the reference signal (e.g., the SRS or training-SRS) in DL sub-band, these two transmissions may not need to apply or use the same timing advance. In some embodiments, for a reference signal (e.g., the SRS or training-SRS) in UL sub-band multiplexed with a reference signal (e.g., the SRS or training-SRS) in DL sub-band, these two transmissions may not need to apply or use the same timing advance.

### Illustrative Implementations

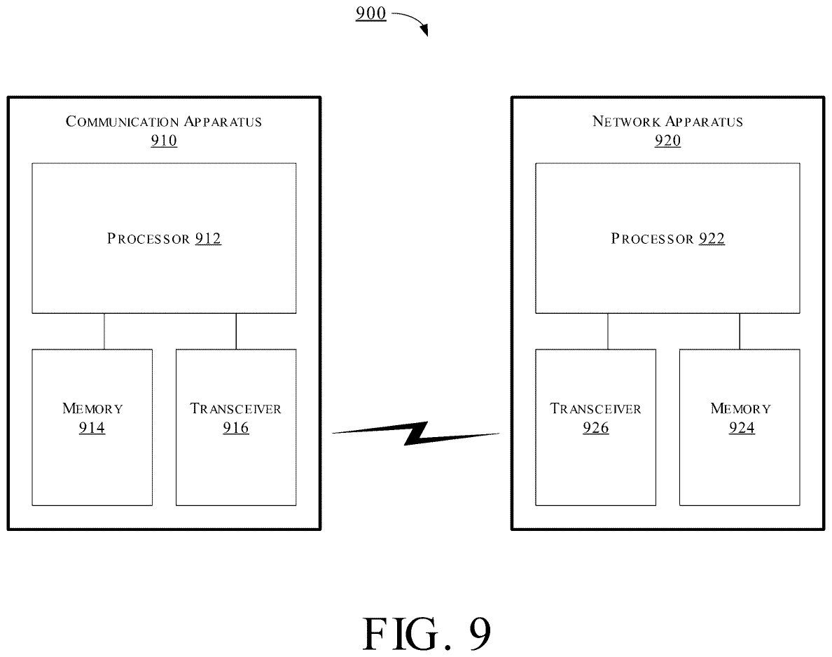

FIG. 9 illustrates an example communication system 900 having an example communication apparatus 910 and an example network apparatus 920 in accordance with an implementation of the present disclosure. Each of the communication apparatus 910 and the network apparatus 920 may perform various functions to implement schemes, techniques, processes and methods described herein pertaining to reference signal transmission in calibration of an interference cancellation operation of a communication apparatus, including scenarios/schemes described above as well as the process 1000 described below.

Communication apparatus 910 may be a part of an electronic apparatus, which may be a UE such as a portable or mobile apparatus, a wearable apparatus, a wireless communication apparatus or a computing apparatus. For instance, the communication apparatus 910 may be implemented in a smartphone, a smartwatch, a personal digital assistant, a digital camera, or a computing equipment such as a tablet computer, a laptop computer or a notebook computer. The communication apparatus 910 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 910 may be implemented in a smart thermostat, a smart fridge, a smart door lock, a wireless speaker or a home control center. Alternatively, the communication apparatus 910 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 910 may include at least some of those components shown in FIG. 9 such as a processor 912, for example. The communication apparatus 910 may further include one or more other components not pertinent to the proposed scheme of the present disclosure (e.g., internal power supply, display device and/or user interface device), and, thus, such component(s) of the communication apparatus 910 are neither shown in FIG. 9 nor described below in the interest of simplicity and brevity.

The network apparatus 920 may be a part of a network device, which may be a network node such as a satellite, a base station, a small cell, a router or a gateway. For instance, the network apparatus 920 may be implemented in an eNodeB in an LTE network, in a gNB in a 5G/NR, IoT, NB-IoT or IIoT network or in a satellite or base station in a 6G network. Alternatively, the network apparatus 920 may be implemented in the form of one or more IC chips such as, for example and without limitation, one or more single-core processors, one or more multi-core processors, or one or more RISC or CISC processors. The network apparatus 920 may include at least some of those components shown in FIG. 9 such as a processor 922, for example. The network apparatus 920 may further include one or more other components not pertinent to the proposed scheme of the present disclosure (e.g., internal power supply, display device and/or user interface device), and, thus, such component(s) of the network apparatus 920 are neither shown in FIG. 9 nor described below in the interest of simplicity and brevity.

In one aspect, each of the processor 912 and the processor 922 may be implemented in the form of one or more single-core processors, one or more multi-core processors, or one or more CISC processors. That is, even though a singular term “a processor” is used herein to refer to the processor 912 and the processor 922, each of the processor 912 and the processor 922 may include multiple processors in some implementations and a single processor in other implementations in accordance with the present disclosure. In another aspect, each of the processor 912 and the processor 922 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 912 and the processor 922 is a special-purpose machine specifically designed, arranged and configured to perform specific tasks including autonomous reliability enhancements in a device (e.g., as represented by communication apparatus 910) and a network (e.g., as represented by network apparatus 920) in accordance with various implementations of the present disclosure.

In some implementations, the communication apparatus 910 may also include a transceiver 916 coupled to the processor 912 and capable of wirelessly transmitting and receiving data. In some implementations, the communication apparatus 910 may further include a memory 914 coupled to the processor 912 and capable of being accessed by the processor 912 and storing data therein. In some implementations, the network apparatus 920 may also include a transceiver 926 coupled to the processor 922 and capable of wirelessly transmitting and receiving data. In some implementations, the network apparatus 920 may have a plurality of physical antennas which associates with a plurality of antenna ports. In some implementations, the network apparatus 920 may further include a memory 924 coupled to processor 922 and capable of being accessed by the processor 922 and storing data therein. Accordingly, communication apparatus 910 and the network apparatus 920 may wirelessly communicate with each other via the transceiver 916 and the transceiver 926, respectively. To aid better understanding, the following description of the operations, functionalities and capabilities of each of the communication apparatus 910 and the network apparatus 920 is provided in the context of a mobile communication environment in which the communication apparatus 910 is implemented in or as an apparatus or a UE and the network apparatus 920 is implemented in or as a network node or a network device of a communication network.

In some implementations, the processor 912 of the communication apparatus 910 may determine a value associated with a timing advance of a reference signal according to a transmission band of the reference signal and transmit, via the transceiver 916, the reference signal in the transmission band with the timing advance. In some implementations, in an event that the transmission band of the reference signal overlaps a downlink sub-band, the value associated with the timing advance may be set to zero.

In some implementations, a timing advance of a transmission in an uplink sub-band may be set to a non-zero value while the value associated with the timing advance of the reference signal may be set to zero, and in transmitting the reference signal in the transmission band with the timing advance, the processor 912 may further align a boundary of the reference signal with a boundary of a downlink symbol in an event that the transmission band of the reference signal overlaps the downlink sub-band.

In some implementations, the timing advance of the reference signal may comprise a timing offset and an adjustment, and the value associated with the timing advance may be a value of the timing offset or a value of the timing advance.

In some implementations, the reference signal may comprise at least one of a pilot signal, an SRS and a Tx IBE RS transmitted for interference cancellation.

In some implementations, the timing advance of the reference signal comprises a timing offset and an adjustment, and the processor 912 may further determine whether to set a value of the timing offset or a value of the timing advance to zero based on a dynamic signaling or a configuration.

In some implementations, in transmitting the reference signal in the transmission band with the timing advance, the processor 912 may further align a boundary of the reference signal with a boundary of an uplink symbol in an event that the transmission band of the reference signal overlaps an uplink sub-band.

In some implementations, a power level of the reference signal may be configured separately from a power level of a sounding reference signal (SRS).

In some implementations, the processor 912 may further set a power level of the reference signal to a predetermined level not higher that a predefined threshold.

In some implementations, the timing advance of the reference signal may be different from a timing advance of a signal or a channel used in an uplink transmission.

In some implementations, in transmitting the reference signal in the transmission band with the timing advance, the processor 912 may further multiplex the reference signal with the uplink transmission in a frequency domain.

In some implementations, the signal or the channel used in the uplink transmission may comprise at least one of a PUSCH, a PUCCH, an SRS and a PRACH in a frequency domain.

### Illustrative Processes

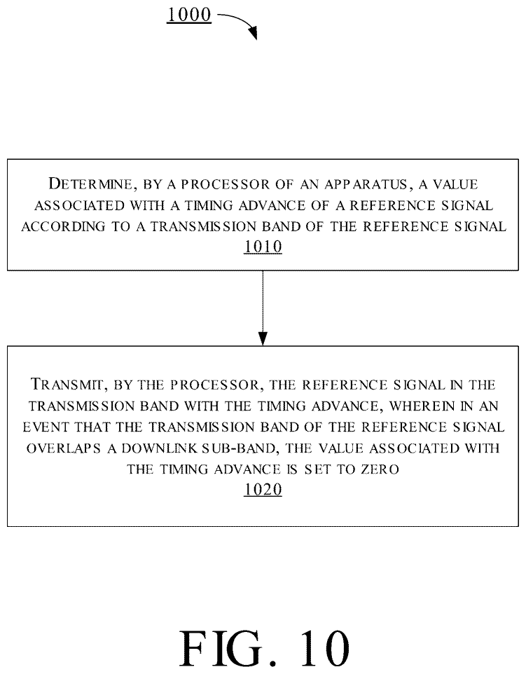

FIG. 10 illustrates an example process 1000 in accordance with an implementation of the present disclosure. The process 1000 may be an example implementation of above scenarios/schemes, whether partially or completely, with respect to calibration of interference cancellation in accordance with the present disclosure. The process 1000 may represent an aspect of implementation of features of the communication apparatus 910. The process 1000 may include one or more operations, actions, or functions as illustrated by one or more of blocks 1010 and 1020. Although illustrated as discrete blocks, various blocks of the process 1000 may be divided into additional blocks, combined into fewer blocks, or eliminated, depending on the desired implementation. Moreover, the blocks of the process 1000 may be executed in the order shown in FIG. 10 or, alternatively, in a different order. The process 1000 may be implemented by the communication apparatus 910 or any suitable UE or machine type devices. Solely for illustrative purposes and without limitation, the process 1000 is described below in the context of the communication apparatus 910. The process 1000 may begin at block 1010.

At 1010, the process 1000 may involve the processor 912 of the communication apparatus 910 determining a value associated with a timing advance of a reference signal according to a transmission band of the reference signal. The process 1000 may proceed from 1010 to 1020.

At 1020, the process 1000 may involve the processor 912 transmitting the reference signal in the transmission band with the timing advance.

In some implementations, in an event that the transmission band of the reference signal overlaps a downlink sub-band, the value associated with the timing advance may be set to zero.

In some implementations, a timing advance of a transmission in an uplink sub-band may be set to a non-zero value while the value associated with the timing advance of the reference signal may be set to zero, and in an event that the transmission band of the reference signal overlaps the downlink sub-band, the process 1000 may involve the processor 912 aligning a boundary of the reference signal with a boundary of a downlink symbol when transmitting the reference signal in an event that the transmission band of the reference signal overlaps the downlink sub-band.

In some implementations, the timing advance of the reference signal may comprise a timing offset and an adjustment, and the value associated with the timing advance may be a value of the timing offset or a value of the timing advance.

In some implementations, the reference signal may comprise at least one of a pilot signal, an SRS and a Tx IBE RS transmitted for interference cancellation.

In some implementations, the timing advance of the reference signal comprises a timing offset and an adjustment, and the process 1000 may involve the processor 912 determining whether to set a value of the timing offset or a value of the timing advance to zero based on a dynamic signaling or a configuration.

In some implementations, in an event that the transmission band of the reference signal overlaps an uplink sub-band, the process 1000 may involve the processor 912 aligning a boundary of the reference signal with a boundary of an uplink symbol when transmitting the reference signal.

In some implementations, a power level of the reference signal may be configured separately from a power level of a sounding reference signal (SRS).

In some implementations, the process 1000 may involve the processor 912 setting a power level of the reference signal to a predetermined level not higher that a predefined threshold.

In some implementations, the timing advance of the reference signal may be different from a timing advance of a signal or a channel used in an uplink transmission.

In some implementations, the process 1000 may involve the processor 912 multiplexing the reference signal with the uplink transmission in a frequency domain when transmitting the reference signal.

In some implementations, the signal or the channel used in the uplink transmission may comprise at least one of a PUSCH, a PUCCH, an SRS and a PRACH in a frequency domain.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, a value associated with a timing advance of a reference signal according to a transmission band of the reference signal; and
transmitting, by the processor, the reference signal in the transmission band with the timing advance,
wherein in an event that the transmission band of the reference signal overlaps a downlink sub-band, the value associated with the timing advance is set to zero.

2. The method of claim 1, wherein a timing advance of a transmission in an uplink sub-band is set to a non-zero value while the value associated with the timing advance of the reference signal is set to zero, and wherein in an event that the transmission band of the reference signal overlaps the downlink sub-band, the transmitting of the reference signal in the transmission band with the timing advance further comprises:
aligning, by the processor, a boundary of the reference signal with a boundary of a downlink symbol.

3. The method of claim 1, wherein the timing advance of the reference signal comprises a timing offset and an adjustment, and wherein the value associated with the timing advance is a value of the timing offset or a value of the timing advance.

4. The method of claim 1, wherein the reference signal comprises at least one of a pilot signal, a sounding reference signal (SRS) and a transmission in-band emission (Tx IBE) reference signal transmitted for interference cancellation.

5. The method of claim 1, wherein the timing advance of the reference signal comprises a timing offset and an adjustment, and wherein the method further comprises:
determining, by the processor, whether to set a value of the timing offset or a value of the timing advance to zero based on a dynamic signaling or a configuration.

6. The method of claim 1, wherein in an event that the transmission band of the reference signal overlaps an uplink sub-band, the transmitting of the reference signal in the transmission band with the timing advance further comprises:
aligning, by the processor, a boundary of the reference signal with a boundary of an uplink symbol.

7. The method of claim 1, wherein a power level of the reference signal is configured separately from a power level of a sounding reference signal (SRS).

8. The method of claim 1, wherein the timing advance of the reference signal is different from a timing advance of a signal or a channel used in an uplink transmission.

9. The method of claim 8, wherein the transmitting of the reference signal in the transmission band with the timing advance further comprises:
multiplexing, by the processor, the reference signal with the uplink transmission in a frequency domain.

10. The method of claim 8, wherein the signal or the channel used in the uplink transmission comprises at least one of a physical uplink shared channel (PUSCH), a physical uplink control channel (PUCCH), a sounding reference signal (SRS) and a physical random access channel (PRACH).

11. An apparatus, comprising:
a transceiver which, during operation, wirelessly communicates with at least one network node; and
a processor communicatively coupled to the transceiver such that, during operation, the processor performs operations comprising:
determining a value associated with a timing advance of a reference signal according to a transmission band of the reference signal; and
transmitting, via the transceiver, the reference signal in the transmission band with the timing advance,
wherein in an event that the transmission band of the reference signal overlaps a downlink sub-band, the value associated with the timing advance is set to zero.

12. The apparatus of claim 11, wherein a timing advance of a transmission in an uplink sub-band is set to a non-zero value while the value associated with the timing advance of the reference signal is set to zero, and wherein, in transmitting the reference signal in the transmission band with the timing advance, the processor further performs operations comprising:
aligning a boundary of the reference signal with a boundary of a downlink symbol in an event that the transmission band of the reference signal overlaps the downlink sub-band.

13. The apparatus of claim 11, wherein the timing advance of the reference signal comprises a timing offset and an adjustment, and wherein the value associated with the timing advance is a value of the timing offset or a value of the timing advance.

14. The apparatus of claim 11, wherein the reference signal comprises at least one of a pilot signal, a sounding reference signal (SRS) and a transmission in-band emission (Tx IBE) reference signal transmitted for interference cancellation.

15. The apparatus of claim 11, wherein the timing advance of the reference signal comprises a timing offset and an adjustment, and wherein, during operation, the processor further performs operations comprising:
determining whether to set a value of the timing offset or a value of the timing advance to zero based on a dynamic signaling or a configuration.

16. The apparatus of claim 11, wherein, in transmitting the reference signal in the transmission band with the timing advance, the processor further performs operations comprising:
aligning a boundary of the reference signal with a boundary of an uplink symbol in an event that the transmission band of the reference signal overlaps an uplink sub-band.

17. The apparatus of claim 11, wherein a power level of the reference signal is configured separately from a power level of a sounding reference signal (SRS).

18. The apparatus of claim 11, wherein the timing advance of the reference signal is different from a timing advance of a signal or a channel used in an uplink transmission.

19. The apparatus of claim 18, wherein, in transmitting the reference signal in the transmission band with the timing advance, the processor further performs operations comprising:
multiplexing the reference signal with the uplink transmission in a frequency domain.

20. The apparatus of claim 18, wherein the signal or the channel used in the uplink transmission comprises at least one of a physical uplink shared channel (PUSCH), a physical uplink control channel (PUCCH), a sounding reference signal (SRS) and a physical random access channel (PRACH) in a frequency domain.
